(19) United States
(12) Patent Application Publication
(10) Pub. No.: US 2003/0060743 A1
(43) Pub. Date: Mar. 27, 2003

(54) Structure of tooth flushing machine

(75) Inventor: Chin Chang Chang, Pan Chiao City (TW)

Correspondence Address: BACON & THOMAS, PLLC, 625 SLATERS LANE, FOURTH FLOOR, ALEXANDRIA, VA, 22314

(73) Assignee: Toong Yee Co.,Ltd.

(21) Appl. No.: 09/956,886

(22) Filed: Sep. 21, 2001

(51) Int. Cl. A61H 13/00; A61C 17/00

(52) U.S. Cl. 601/162; 433/80

(57) ABSTRACT

An improved structure of tooth flushing machine provided therein with an ozone generator, ozone is mixed with the rinsing water in the machine for cleaning and sterilizing an oral cavity. The machine includes a water supplying portion and a flushing portion; and is provided therein with a water supplying pump and an ozone generator communicating with each other. A water inlet on the water supplying pump is connected with a water storing cup in the water supplying portion, and an water outlet on the pump is connected with a flushing bar on the flushing portion. By way that the water supplying pump draws the water from the water storing cup into the water supplying portion, meantime, the ozone generator sends ozone into the water supplying pump to mix uniformly with the water in the pump, then the water with the ozone is put out of the water outlet into the flushing bar for cleaning, sterilizing the oral cavity to keep cleanliness of the latter.

### BACKGROUND OF THE INVENTION

1. Field of the Invention

The present invention is related to an improved structure of tooth flushing machine, and especially to the structure of tooth flushing machine provided therein with an ozone generator, wherein the flushing water from the tooth flushing machine contains ozone molecules, so that the oral cavity can be cleaned and sterilized. And the object of having clean and sanitary oral cavities can be achieved.

2. Description of the Prior Art

Among parts and organs of a human body, an oral cavity is an extremely important organ, in addition to presentation of ideas, an oral cavity has another primary function, i.e., chewing foods, drinking water and eating foods in the three meals every day. The principal object of drinking and eating is to supplement the consumed physical energy of human and to enhance organic functions of human; thereby, human can have more physical energy and vitality to do many other works. In this view, an oral cavity of a human body has the important function of supplementing physical energy which function can not be substituted by any of other organs, hence sanitation and health care of it shall be well done to make the oral cavity clean and healthy every day.

Germs and bacteria in foods or water can enter an oral cavity when in drinking and eating; these minor germs and bacteria may have no significant harm to the human body, but staying of them in the oral cavity can more or less affects the cleanliness and sanitation of the oral cavity. Some people clean and keep health of their oral cavities by tooth brushing which must have a tooth brush applied with tooth paste or tooth powder for tooth brushing; people too young or too old may be unable to suffer from stimulation of tooth paste or tooth powder and thereby can not make the work of health care of their oral cavities by tooth brushing other than mouth-rinsing with water. Although the mode of tooth brushing may make oral cavities clean, the work of brushing must be correct and persistent. However, people normally are not so positive in dealing with tooth brushing, they mostly brush their teeth just with a few moves before mouth-rinsing with water. At the locations such as those seams between teeth or the dead corners in an oral cavity where a toothbrush can not access, no cleaning function can be effected; and the object of tooth brushing can not be obtained, cleaning of oral cavities is still not adequate.

Furthermore, a dentist or some people may use a tooth-flushing machine to clean their oral cavities, by using the flushing bar of the tooth-flushing machine to concentrate the water column for flushing the oral cavities, every location in the oral cavities can be adequately flushed, the residues in the seams between teeth can be moved out. Such machine is more effective in cleaning the oral cavities as compared to the mode of tooth flushing. However, the tooth-flushing machines available presently only provide water to flush for cleansing, they can not sterilize or make health care for the oral cavities; thereby, cleaning of oral cavities is unable to be perfect.

In view that an oral cavity is an extremely important organ, the inventor of the present invention is aware of that a more perfect equipment for health care of oral cavities shall be given for the works of cleaning, sanitation as well as health care of oral cavities, this in turn is good for health of people. However, the modes of health care of oral cavities can not provide sufficient perfect functions of cleaning and sterilizing, improvement is required.

### SUMMARY OF THE INVENTION

The inventor of the present invention studied and developed the improved structure of tooth flushing machine based on his practical experience of years in designing, production and selling of the products of such kind after repeated experiments, tests and tries. By providing an ozone generator in a tooth-flushing machine, ozone can be generated during mouth rinsing by the tooth-flushing machine with water to sterilize in and make health care of an oral cavity.

The primary object of the present invention is: an ozone generator is provided in a tooth-flushing machine, ozone can be generated accompanied with the flushing water during mouth rinsing with the water provided by a water pump to sterilize in and make health care of an oral cavity with the ozone.

The secondary object of the present invention is: the ozone generator is formed from an electric circuit board, a high-voltage durable electric wire (made of silicone rubber) and a pipe like conductor. By giving a high voltage with a predetermined value acceptable for the high-voltage durable electric wire to a connecting point on the electric circuit board, a dielectric is formed on the insulation surface layer of the high-voltage durable electric wire to form a space having electric halation (corona), thereby, the air in the space having the electric halation effects electric discharging under a high voltage, and ozone is generated.

The present invention will be apparent in its particular structural characteristics and modes of use after reading the detailed description of the preferred embodiment thereof in reference to the accompanying drawings.

### BRIEF DESCRIPTION OF THE DRAWINGS

FIG. 1 is an analytical perspective view of the present invention;

FIG. 2 is an analytical perspective view of an ozone generating device in the ozone generator of the present invention;

FIG. 3 is a perspective view of the ozone generating device of the present invention;

FIG. 4 is a perspective view of an embodiment of the ozone generating device of the present invention provided with an electric conductive piece;

FIG. 5 is a perspective view of another embodiment of the ozone generating device of the present invention provided with a different pipe like conductor.

### DETAILED DESCRIPTION OF THE PREFERRED EMBODIMENT

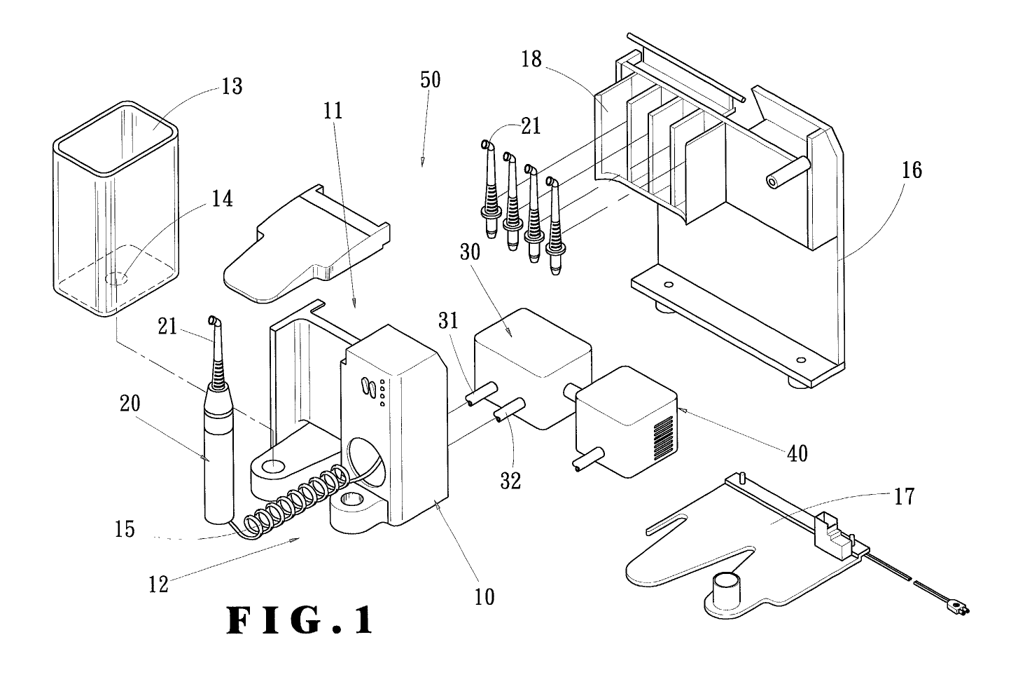

Referring to FIG. 1, a tooth-flushing machine 50 of the present invention is comprised mainly of a main body 10, a flushing bar 20, a water supplying pump 30 and an ozone generator 40.

Wherein, the main body 10 is provided with a water supplying portion 11 and a flushing portion 12. The water supplying portion 11 has a water storing cup 13 with a water supplying hole 14 on the bottom thereof connecting to a water inlet 31 of the water supplying pump 30 via the main body 10; the water supplying pump 30 is located in the flushing portion 12 provided juxtaposed to the water supplying portion 11. An extendible water supplying pipe 15 is connected with the flushing bar 20 and is connected rearwardly to a water outlet 32 of the water supplying pump 30. A rear plate 16 is provided behind the water supplying portion 11 and the flushing portion 12 and is provided with a separating rack 18 for receiving therein a plurality of flushing heads 21 for the flushing bar 20. And a control plate 17 is provided beneath the main body 10 and has a power line connected to an electric power for supplying power for the main body 10.

The flushing bar 20 can be mounted thereon a flushing head 21 which is removable, and can be connected with the extendible water supplying pipe 15 of the main body 10.

The water supplying pump 30 is mounted in the main body 10 and includes the water inlet 31 and the water outlet 32. The water inlet 31 is connected with the water supplying portion 11 of the main body 10, while the water outlet 32 is connected with the flushing portion 12. The water supplying pump 30 is connected with the ozone generator 40 juxtaposed thereto. When water is put out from the water outlet 32 of the water supplying pump 30 for rinsing, ozone can be generated by the ozone generator 40 to mix with the water.

The ozone generator 40 is mounted in the main body 10, and is connected with and juxtaposed to the water supplying pump 30, the ozone generated can be sent into the water supplying pump 30.

With the above members, when in flushing of the flushing portion 12 of the main body 10, the water supplying pump 30 draws the water from the water storing cup 13 into the water supplying portion 11, meantime, the ozone generator 40 sends ozone into the water supplying pump 30 to mix uniformly with the water in the water supplying pump 30, then the water with the ozone is put out of the water outlet 32 into the flushing bar 20 through the extendible water supplying pipe 15, and then flushed out of the flushing head 21 for cleaning, sterilizing an oral cavity to thereby keep cleanliness of the oral cavity.

Referring to FIG. 1, 2 and 3, the ozone generator 40 of the present invention includes an ozone generating device 41 which is comprised mainly of a pipe like electric conductive member 42, an electric circuit board 43 and a high-voltage durable electric wire 44 (made of silicone rubber), wherein:

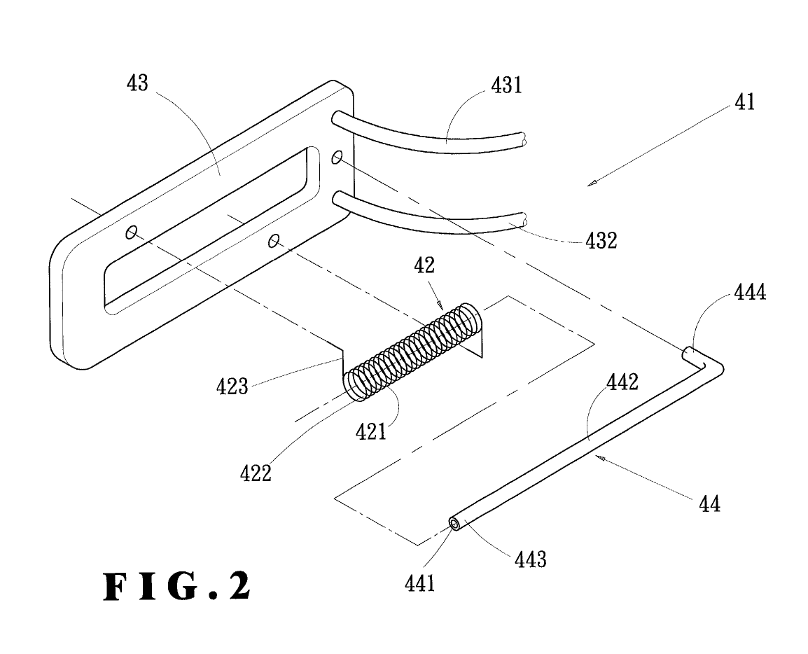

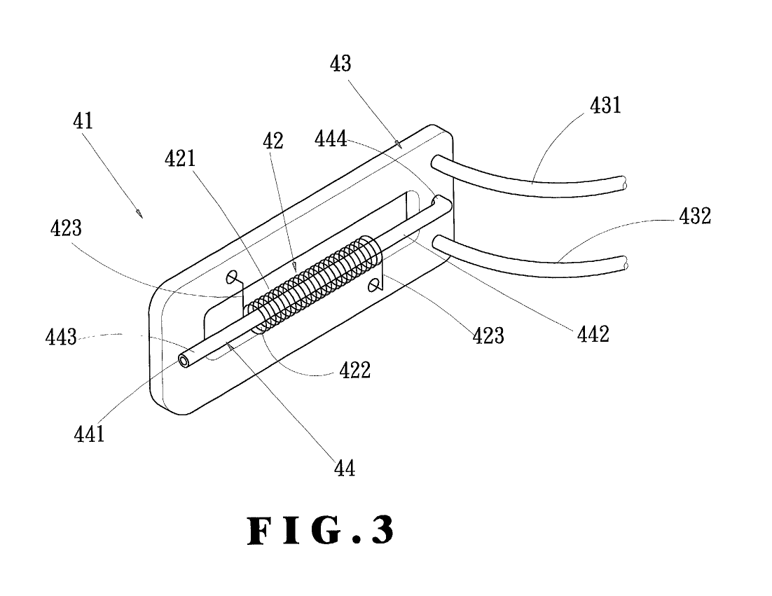

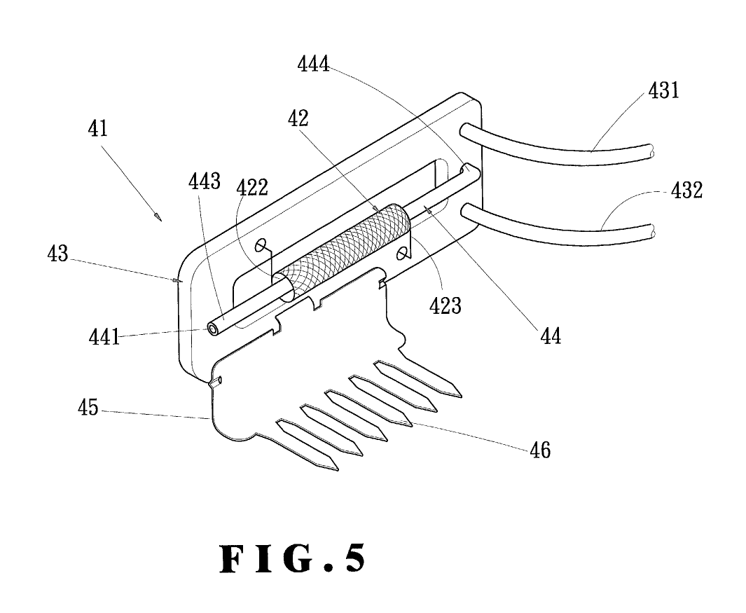

The pipe like electric conductive member 42 is made from a stainless steel wire 421 which is uneasy to be oxidized and is helically wound to form the shape of a helix spring (alternatively, the pipe like electric conductive member 42 can be made by two mutually crossing wires forming the shape of a pipe as shown in FIG. 5), and is formed to have a central passage 422, both ends 423 thereof are fixed to the electric circuit board 43 (as shown in FIG. 2 and 3).

The electric circuit board 43 has a first connecting point 431 and a second connecting point 432. Wherein, the first connecting point 431 is connected to both ends 423 of the pipe like electric conductive member 42, while the second connecting point 432 is connected with the high-voltage durable electric wire 44.

The high-voltage durable electric wire 44 made of silicone rubber includes an inner conductor 441 and a surface insulation layer 442 being longer than the pipe like electric conductive member 42, one end of the high-voltage durable electric wire 44 is a free end 443 which extends through the central passage 422 of the pipe like electric conductive member 42 and out of the latter, the other end of the high-voltage durable electric wire 44 is an electric conductive end 444 being welded to the second connecting point 432 of the electric circuit board 43.

When the first connecting point 431 and the second connecting point 432 are given with a high voltage under the predetermined value regulated for the high-voltage durable electric wire 44, the surface insulation layer 442 of the high-voltage durable electric wire 44 forms a dielectric between the inner conductor 441 and the pipe like electric conductive member 42, thereby, the power source forms on the insulation surface layer of the high-voltage durable electric wire 44 a space having electric halation (corona), the air in the space having the electric halation effects electric discharging under a high voltage, and ozone is generated and is delivered to the flushing portion 12 of the main body 10.(as shown in FIG. 1)

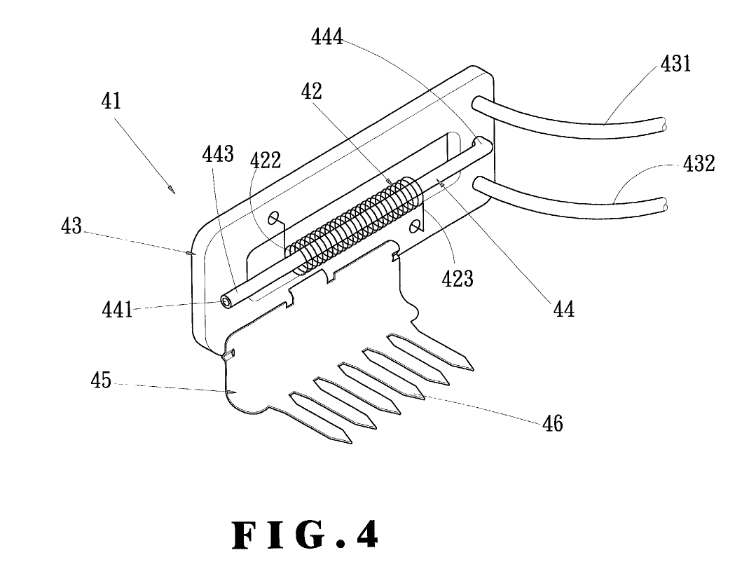

As shown in FIG. 4, an electric conductive piece 45 is provided for the ozone generating device 41 and is provided with a plurality of mutually separated prongs with tips 46. In this way, when the ozone generating device 41 is given with a voltage of direct current, a state like blowing of natural wind onto the tips of leaves and grasses can be formed, and anions are generated on the tips 46 and can remove impurities in water, so that the water can be cleaner and more hygienic.

In conclusion, combination of the tooth-flushing machine and the ozone generator renders the ozone generated by the ozone generator deliverable into the water supplying pump of the main body. When in using the tooth-flushing machine, water flushed out of the flushing head on the flushing bar contains molecules of ozone and can be used to rinse an oral cavity for health care and sterilization, thereby, sanitation and cleanliness of the oral cavity can be obtained. Having now particularly described and ascertained the nature of my invention and in what manner the same is to be performed, we declare that what we claim are:

1. An improved structure of tooth flushing machine comprising a main body, a flushing bar, a water supplying pump and an ozone generator, wherein,
said main body is provided with a water supplying portion and a flushing portion, said water supplying portion has a water storing cup to store water, said flushing portion is provided with a water supplying pipe; said flushing bar is mounted thereon with a flushing head and is connected downwardly with a flushing portion of said main body; a water supplying pump is provided in said main body and is provided with a water inlet and a water outlet, said water inlet is connecting to said water supplying portion of said main body;
said ozone generator is provided in said main body juxtaposed to said water supplying pump and generates ozone to be delivered into said water outlet of said water supplying pump;
when said flushing portion of said main body is to do rinsing, said water supplying pump draws water from said water storing cup into said water supplying portion, and said ozone generator sends ozone into said water supplying pump to mix uniformly with the water in said water supplying pump, then the water with the ozone is put out of said water outlet into said flushing bar through said water supplying pipe of said flushing portion, and then flushed out of said flushing head for cleaning, sterilizing an oral cavity.

2. An improved structure of tooth flushing machine as in claim 1, wherein, said ozone generator is provided with an ozone generating device comprising a pipe like electric conductive member, an electric circuit board and a high-voltage durable electric wire made of silicone rubber, wherein:
said pipe like electric conductive member is made from a stainless steel wire which is uneasy to be oxidized and is helically wound to form the shape of a helix spring, and is formed to have a central passage, both ends thereof are fixed to said electric circuit board;
said electric circuit board has a first connecting point and a second connecting point;
said high-voltage durable electric wire includes an inner conductor and a surface insulation layer, one end of said high-voltage durable electric wire is a free end, the other end of said high-voltage durable electric wire is an electric conductive end being welded to said second connecting point of said electric circuit board;
when said first connecting point and second connecting point are given with a high voltage under the predetermined value regulated for said high-voltage durable electric wire, said surface insulation layer of said high-voltage durable electric wire forms a dielectric between said inner conductor and said pipe like electric conductive member, thereby, a power source forms on said insulation surface layer of said high-voltage durable electric wire a space having electric halation (corona), the air in said space having said electric halation effects electric discharging under a high voltage, and ozone is generated and is delivered to said flushing portion of said main body.

3. An improved structure of tooth flushing machine as in claim 1, wherein, said water storing cup in said water supplying portion of said main body has a water supplying hole on the bottom thereof connecting to a water inlet of said water supplying pump via said main body.

4. An improved structure of tooth flushing machine as in claim 1, wherein, a rear plate is provided at the rear of said main body for mounting of said main body thereon, said the rear plate is provided with a separating rack for receiving therein a plurality of flushing heads.

5. An improved structure of tooth flushing machine as in claim 1, wherein, a control plate is provided beneath said main body and has a power line connected to an electric power for supplying power for the main body.

6. An improved structure of tooth flushing machine as in claim 1, wherein, said water supplying pipe of said water supplying portion is in a wound shape and is extendible.
